(19) United States
(12) Patent Application Publication
(10) Pub. No.: US 2017/0328431 A1
(43) Pub. Date: Nov. 16, 2017

(54) POWER BOOSTER

(71) Applicants: Guangrong XU, Chengdu (CN); Bin MAO, Chengdu (CN); Jialu XU, Chengdu (CN)

(72) Inventors: Guangrong XU, Chengdu (CN); Bin MAO, Chengdu (CN); Jialu XU, Chengdu (CN)

(21) Appl. No.: 15/524,629

(22) PCT Filed: Oct. 30, 2015
(86) PCT No.: PCT/CN2015/000733

§ 371 Date: May 5, 2017

(30) Foreign Application Priority Data
Nov. 7, 2014 (CN) 201420661632.8

(51) Int. Cl. F16D 65/18; F16D 65/22; F16D 55/226; F16D 51/50; F16D 121/04; F16D 121/14; F16D 127/08

(52) U.S. Cl. CPC F16D 65/18; F16D 55/226; F16D 65/22; F16D 51/50; F16D 2121/14; F16D 2127/08; F16D 2127/085; F16D 2121/04

(57) ABSTRACT

A power booster includes a conversion device, a power boosting component, a power boosting friction block, a friction part, a power boosting support, a sliding device. The conversion device is fixed to the power boosting component, the power boosting friction block is fixed to the power boosting component, the power boosting friction block and the friction part contact with each other after being pressed, the power boosting component is movably connected to the power boosting support, the friction part is movably connected to the power boosting support, the sliding device is connected to the power boosting component and the power boosting support. The power booster introduces the controlling force from the inlet, and amplifies the controlling force. The amplified controlling force is output by the power boosting component to push the part that needs to be controlled.

### CROSS REFERENCE TO RELATED APPLICATIONS

This application is the national phase entry of International Application No. PCT/CN2015000733, filed on Oct. 30, 2015, which is based upon and claims priority to Chinese Patent Application No. 201420661632.8 filed on Nov. 7, 2014, the entire contents of which are incorporated herein by reference.

### TECHNICAL FIELD

The present invention relates to a mechanical device, specifically to a power booster.

### BACKGROUND OF THE INVENTION

At present, mechanical apparatus is usually manually operated and controlled. For a simple and convenient operation, the methods of electrical control, pneumatic control, etc. and sometimes vacuum power boosting are used by man. However, the apparatus using methods controlled by the electrical, the pneumatic power boosting, or the vacuum pump power boosting, not only consumes high energy, but is also prone to accidents caused by the control system failure due to power outage or when the engine stops operating. Even if the machine is doing useless work, for ensuring the regular working of the controlling force, the machine sometimes is required to work continuously, such that the precious energy is greatly wasted, and the environment is polluted more seriously. For instance, to avoid serious accidents such as brake failure etc. if the engine stops working, the automobile cannot be driven and slide in neutral gear when traveling downhill. Therefore, there are drawbacks such as an unwanted consumption of the fuel when traveling downhill, etc.

### SUMMARY OF THE INVENTION

The power booster of the present invention generates the boosting power by a running part of the mechanical apparatuses, which is different from the methods that use electric energy, compressed gas etc., and is also different from the vacuum boosting power generated by the running of the engine. The power booster of the present invention would not cause the accident of the control system failure owing to the power outage, the lack of pressure of the compressed gas or the stopping of engine etc. The power booster of the present invention could be applied on most of the mechanical apparatuses having a running part, particularly suitable for a braking system, in which the running part that needs braking is utilized for generating boosting power. As long as the part is running, the boosting power may not disappear, thereby without consuming the precious energy, the power booster is safe and reliable.

To solve the technical problems, the technical solution adopted by the present invention is as follows: a power booster includes the conversion device, the power boosting component, the power boosting friction block, the frictional part, the power boosting support, the resetting device, and the sliding device.

The conversion device is connected to the parts of an external controlling device, and is fixedly connected to the power boosting component. The power boosting friction block is movably or fixedly connected to the power boosting component. The power boosting friction block and the friction part contact with each other after being pressed. The power boosting component is slidably connected to the power boosting support. The friction part is movably connected to the power boosting support. The resetting device is connected to the power boosting component and the power boosting support. The sliding device is fixed to the power boosting component and the power boosting support. The power boosting component is connected to the parts to be controlled.

The power boosting friction block slides back and forth relative to the power boosting component along the direction perpendicular to the moving direction of the frictional part. The power boosting component slides back and forth relative to the power boosting support along the moving direction of the frictional part.

The conversion device includes the hydraulic tube inlet, the liquid cylinder, and the piston. The hydraulic tube inlet is fixedly connected to the liquid cylinder. The liquid cylinder is fixed to the power boosting component. The piston is arranged inside the liquid cylinder. The piston is movably connected to the power boosting friction block. The power boosting component includes the power boosting block, and the concave shaped limiting device. The power boosting friction block includes the first friction block. The resetting device includes the spring. The sliding device includes the slide groove and the slide rod. The first friction block is fixed to the concave shaped limiting device. Two ends of the spring are respectively fixed to the power boosting component and the power boosting support. The slide groove and the slide rod are respectively fixed to the power boosting component and the power boosting support, the slide rod moves back and forth along the slide groove. The friction part includes the turntable which is movably connected inside the power boosting support, the power boosting friction block and the turntable contact each other after being pressed.

As another preferred solution of the present invention, the conversion device includes the tension cable support, the cam, the camshaft, and the cam support. The tension cable support is fixedly connected to the power boosting component. The cam is arranged around the camshaft. The camshaft is arranged inside the cam support.

The cam support is fixedly connected to the power boosting component. The cam radially rotates around the camshaft and is movably connected to the power boosting friction block. The power boosting component includes the power boosting block, and the convex shaped limiting device. The power boosting friction block includes the second friction block. The resetting device includes the leaf spring. The sliding device includes the slide way, and the slide rail. The power boosting component includes the power boosting block, and the convex shaped limiting device where the second friction block is fixed, two ends of the leaf spring are respectively connected to the power boosting component and the power boosting support, the slide way and the slide rail are respectively positioned on the power boosting component and the power boosting support, the slide rail moves back and forth along the slide way. The friction part includes the turntable which is arranged inside and movably connected to the power boosting support, the power boosting friction block and the turntable contact each other after being pressed.

As another preferred solution of the present invention, the power boosting component includes the power boosting toothed block, the sliding device includes the slide ring, and slide shaft. The power boosting component has the power boosting toothed block and the slide ring, the slide shaft is fixed to the power boosting support, the slide ring is arranged around the slide shaft and the slide ring slides around the slide shaft. The friction part includes the rotating drum which is arranged inside and movably connected to the power boosting support, the power boosting friction block and the rotating drum contact with each other after being pressed.

The working process of the power booster is provided as follows: An external controlling power is transmitted to the conversion device which applies the power on the power boosting friction block. The power boosting friction block moves toward the running friction part to contact with each other and generate friction accordingly. The bigger the power is, the bigger the friction is. When the friction is higher than the acting force of the resetting device, the power boosting friction block follows the movement of the friction part along the guiding sliding device in a same direction, while the displacement between the friction block and the power boosting component is not allowed in this direction of plane. Therefore, the power boosting component moves together with the power boosting friction block, under the combined actions of the frictional part, the power boosting friction block, and the power boosting component, an amplified boosting power is generated in the same moving direction as the frictional part. The boosting power is transmitted to the part that needs to be controlled by the power boosting component, so as to control the operation of the mechanical apparatuses.

Compared with the prior art, the beneficial effects of the present invention are provided as below.

The power booster of the present invention relates to a structure generating the boosting power by utilizing the running part, which can be any running component of a machine. Certainly, if the power booster is used for deceleration or braking, it is more preferable to utilize the part that needs decelerating or braking, such that not only no energy is consumed by the power booster, but also a function of auxiliary brake is provided. As long as the part that needs decelerating or braking does not stop running, the boosting power of the braking may not disappear and also function as an auxiliary brake, thereby it is safe and reliable. The power booster also has advantages of a compact structure, simple and convenient operation, and low production and repair costs, etc. Therefore, the power booster can be applied to many transportation and mechanical apparatuses that need braking or controlling.

### BRIEF DESCRIPTION OF THE DRAWINGS

Hereinafter, with reference to the drawings and embodiments, the present invention is further described.

FIG. 1 is a structural diagram of embodiment 1 of the present invention;

FIG. 2 is an A-A cross-section diagram of FIG. 1;

FIG. 3 is a cross-section diagram of the driving component of FIG. 1;

FIG. 4 is a structural diagram of embodiment 2 of the present invention;

FIG. 5 is an A-A cross-section diagram of FIG. 4;

FIG. 6 is a structural diagram of embodiment 3 of the present invention;

FIG. 7 is an A-A cross-section diagram of FIG. 6;

FIG. 8 is a structural diagram of embodiment 4 of the present invention;

FIG. 9 is an A-A cross-section diagram of FIG. 8;

FIG. 10 is a structural diagram of embodiment 5 of the present invention;

FIG. 11 is an A-A cross-section diagram of FIG. 10;

FIG. 12 is a structural diagram of embodiment 6 of the present invention;

FIG. 13 is an A-A cross-section diagram of FIG. 12.

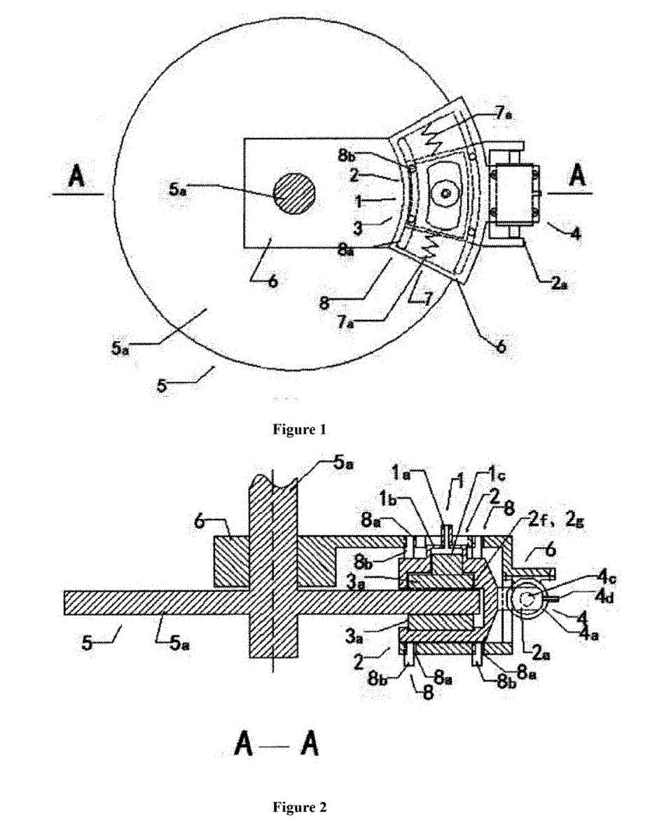

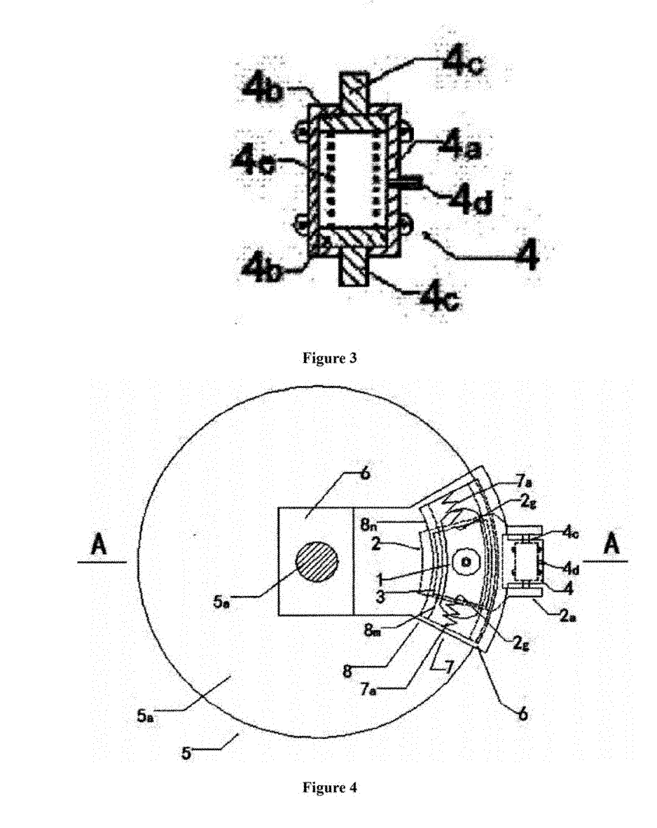

The components of the power booster shown in FIG. 1, FIG. 2, and FIG. 3: 1—conversion device, 1a—hydraulic tube inlet, 1b—liquid cylinder, 1c—piston, 2—power boosting component, 2a—power boosting block, 2f—concave shaped limiting device, 3—power boosting friction block, 3a—the first friction block, 4—driving component, 4a—hydraulic cylinder, 4b—piston, 4c—piston push rod, 4d—hydraulic tube outlet, 4e—spring, 5—frictional part, 5a—turntable, 6—power boosting support, 7—resetting device, 7a—spring, 8—sliding device, 8a—slide groove, 8b—slide rod.

The components of the power booster shown in FIG. 4, and FIG. 5: 1—conversion device, 1a—hydraulic tube inlet, 1b—liquid cylinder, 1c—piston, 2—power boosting component, 2a—power boosting block, 2g—convex shaped limiting device, 3—power boosting friction block, 3b—the second friction block, 4—driving component, 4c—piston push rod, 4d—hydraulic tube outlet, 5—frictional part, 5a—turntable, 6—power boosting support, 7—resetting device, 7a—spring, 8—sliding device, 8m—slide way, 8n—slide rail.

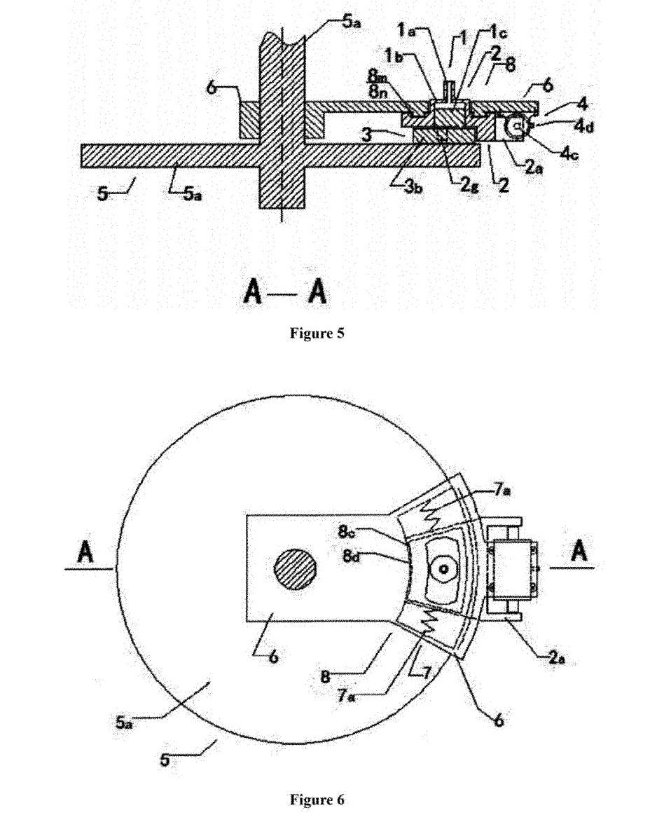

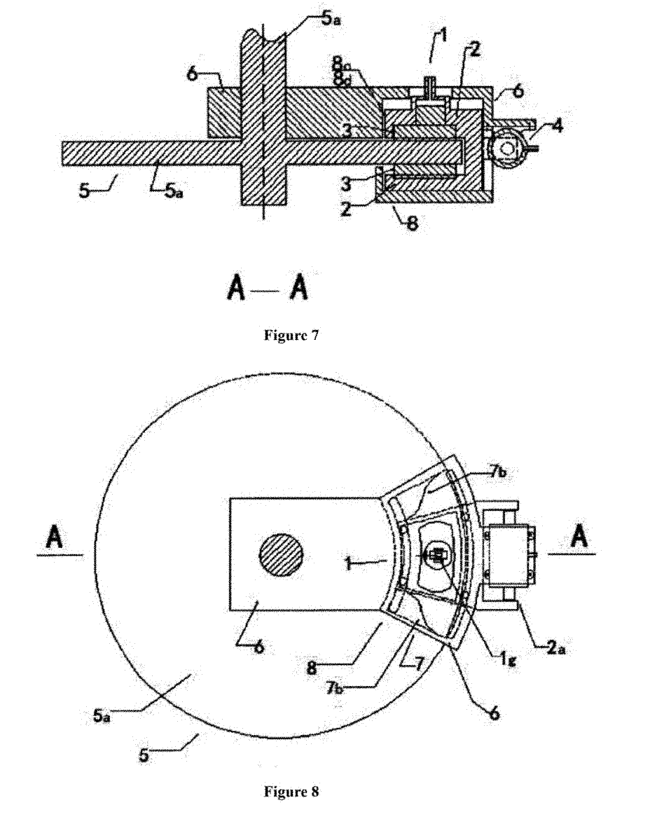

The components of the power booster shown in FIG. 6, and FIG. 7 are basically the same with FIG. 1, FIG. 2, and FIG. 3, the differences are that slide groove 8a of sliding device is replaced by 8c—slide ditch, slide rod 8b is replaced by 8d—slide block.

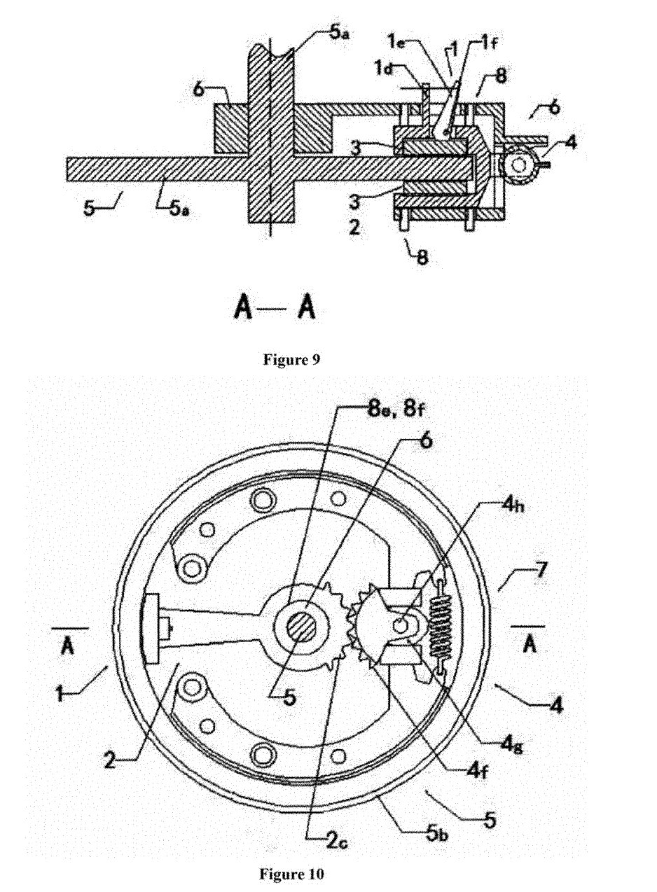

The components of the power booster shown in FIG. 8, and FIG. 9 are basically the same with FIG. 1, FIG. 2, and FIG. 3 or FIG. 4, and FIG. 5, the differences are that conversion device 1 is changed from a hydraulic structure to a mechanical structure, hydraulic tube inlet 1a, liquid cylinder 1b, and piston 1c are removed, 1d—tension cable support, 1e—cam (or lever), 1f—camshaft (or lever shaft), and 1g—cam support (lever support) are added, and resetting device is changed from spring 7a to 7b—leaf spring.

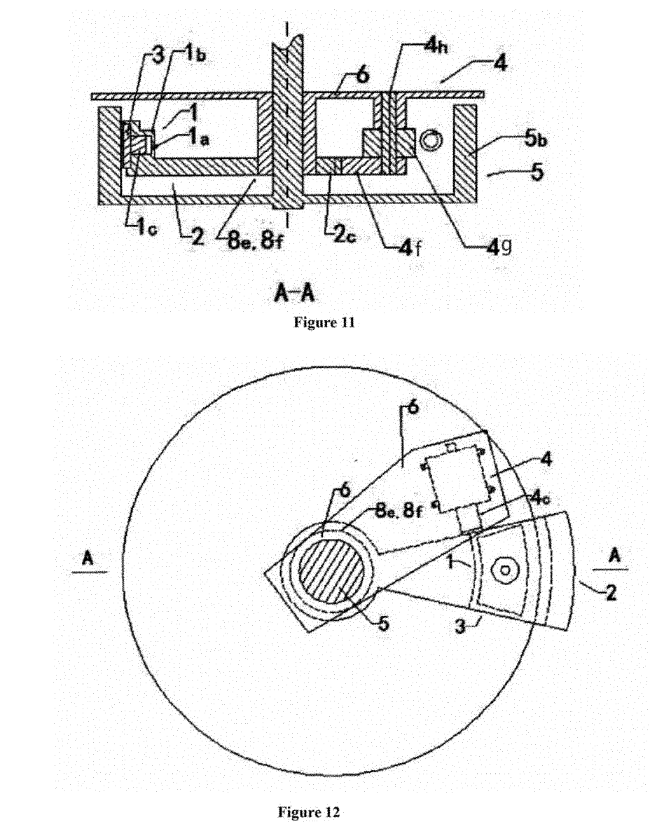

The components of the power booster shown in FIG. 10, and FIG. 11: 1—conversion device, 2—power boosting component, 2c—power boosting toothed block, 3—power boosting friction block, 4—driving component, 4g—cam, 4h—camshaft, 5—frictional part, 5b—rotating drum, 6—power boosting support, 8—sliding device, 8m—slide ring, 8n—slide shaft.

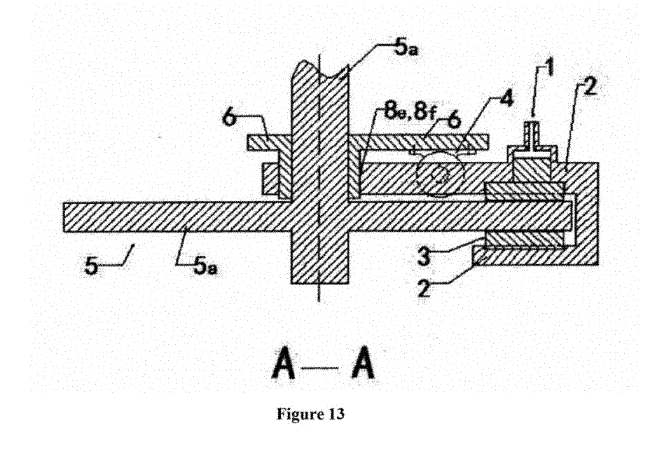

The components of the power booster shown in FIG. 12, and FIG. 13 are basically the same with FIG. 1, FIG. 2, FIG. 3, FIG. 4, FIG. 8, or FIG. 9, the difference is that power boosting component 2 does not have a block.

### DETAILED DESCRIPTION OF THE INVENTION

### Embodiment 1

As shown in FIG. 1, FIG. 2, and FIG. 3, the power booster of embodiment 1 includes conversion device 1, power boosting component 2, power boosting friction block 3, driving component 4, friction part 5, power boosting support 6, resetting device 7, sliding device 8. The conversion device 1 includes hydraulic tube inlet 1a, liquid cylinder 1b, piston 1c. Power boosting component 2 includes power boosting block 2a, concave shaped limiting device 2f. Power boosting friction block 3 includes first friction block 3a. Driving component 4 includes hydraulic cylinder 4a, piston 4b, piston push rod 4c, hydraulic tube outlet 4d, spring 4e. Friction part 5 includes turntable 5a. Resetting device 7 is spring 7a (the compression spring or the tension spring). Sliding device 8 includes slide groove 8a and slide rod 8b.

The hydraulic tube inlet 1a is hermetically connected to the hydraulic tube of the external controlling device and further fixedly connected to liquid cylinder 1b which is also fixedly connected to power boosting component 2. Piston 1c is arranged and movably connected inside liquid cylinder 1b. One of first friction blocks 3a is movably connected to piston 1c, first friction block 3a is also movably connected to concave shaped limiting device 2f. Under the limitation of the concave shaped limiting device 2f, first friction block 3a, together with power boosting component 2, is only enabled to move back and forth along the direction perpendicular to the moving direction of friction part 5. Another first friction block 3a is fixedly connected to power boosting component 2. First friction block 3a and the friction part 5 are in a contact connection after being pressed. Slide groove 8a and slide rod 8b are respectively fixed on power boosting support 6 and power boosting component 2. Power boosting block 2a is movably connected to piston push rod 4c, which is arranged on and connected to hydraulic cylinder 4a, and the piston 4b is arranged inside hydraulic cylinder 4a. Hydraulic tube outlet 4d is fixed on hydraulic cylinder 4a, spring 4e is fixed on piston 4b, two ends of spring 7a are respectively fixed on power boosting component 2 and power boosting support 6. Hydraulic tube outlet 4d is fixedly connected to hydraulic cylinder 4a and connected to the controlling part of the mechanical apparatus which needs to be controlled. Turntable 5a is arranged inside and movably connected to power boosting support 6.

The piston 1c is enabled to move up and down inside liquid cylinder 1b, first friction block 3a follows piston 1c to move up and down. Power boosting component 2 slides back and forth relative to power boosting support 6 along the direction parallel to the moving direction of friction part 5, which is enabled to move rotatably on power boosting support 6.

When the power booster of embodiment 1 is working: The pressure is applied to hydraulic tube inlet 1a of conversion device 1 from external controlling power by hydraulic tube. The liquid inside liquid cylinder 1b enables piston 1c to push first friction block 3a to move towards friction part 5 and contact each other, so as to generate friction. As the pressure is increased, the friction is also increased. When the friction is more than the restoring force of spring 7a of resetting device 7, first friction block 3a would follow friction part 5 to move in the same direction, while under the limitation of convex shaped limiting device 2f, a displacement between first friction block 3a and power boosting component 2 is not allowed in this moving direction. Therefore, first friction block 3a and power boosting component 2 move in the same direction. Under the friction between friction part 5 and first friction block 3a, an amplified power, i.e., the boosting power, is generated. Power boosting component 2 outputs the boosting power to piston push rod 4c of the pan to be controlled. Piston push rod 4c pushes piston 4b to compress the liquid.

### Embodiment 2

As shown in FIG. 3, FIG. 4, and FIG. 5, the power booster of embodiment 2 includes conversion device 1, power boosting component 2, power boosting friction block 3, driving component 4, friction part 5, power boosting support 6, resetting device 7, sliding device 8. The conversion device 1 includes hydraulic tube inlet 1a, liquid cylinder 1b, and piston 1c. Power boosting component 2 includes power boosting block 2a, convex shaped limiting device 2g (e.g. in a shape of rod, convex block, or rail). Power boosting friction block 3 includes second friction block 3b. Driving component 4 includes piston push rod 4c, and hydraulic tube outlet 44. Friction pan 5 includes turntable 5a. Resetting device 7 is spring 7a. Sliding device 8 includes sliding slide way 8m and slide rail 8n.

The hydraulic tube inlet 1a is hermetically connected to the hydraulic tube of the external controlling device and further fixedly connected to liquid cylinder 1b, which is also fixedly connected to power boosting component 2. Piston 1c is arranged inside and movably connected to liquid cylinder 1b. Second friction block 3b is movably connected to piston 1c, and also movably connected to convex shaped limiting device 2g. Under the limitation of the convex shaped limiting device 2g, second friction block 3b, together with power boosting component 2, is enabled to move back and forth along the direction perpendicular to the moving direction of friction part 5 and is not allowed to move along the moving direction of friction part 5. Second friction block 3b and the friction part 5 are contact each other after being pressed. Slide way 8m and slide rail 8n are respectively fixed on power boosting support 6 and power boosting component 2. Power boosting block 2a is movably connected to piston push rod 4c, which is arranged on and connected to hydraulic cylinder 4a, and the piston 4b is arranged inside hydraulic cylinder 4a. Hydraulic tube outlet 4d is fixed on hydraulic cylinder 4a, spring 4e is fixed on piston 4b, two ends of spring 7a are respectively fixed on power boosting component 2 and power boosting support 6. Hydraulic tube outlet 4d is fixedly connected to hydraulic cylinder 4a and connected to the controlling part of the mechanical apparatus which needs to be controlled. Turntable 5a is arranged inside and movably connected to power boosting support 6.

The piston 1c is enabled to move up and down repeatedly inside liquid cylinder 1b, second friction block 3b follows piston 1c to move up and down repeatedly. Power boosting component 2 slides back and forth relative to power boosting support 6 along the direction parallel to the moving direction of friction part 5, which is enabled to move rotatably on power boosting support 6.

When the power booster of embodiment 2 is working:

The basic structure of this embodiment is the same as embodiment 1, the differences are that piston 1c pushes second friction block 3b to move towards friction part 5 in motion and contact with each other to generate pressure. Although a pressure is generated between sliding slide way 8m and slide rail 8n by the reaction of the former pressure, and a friction is also generated by the mutual movement between sliding slide way 8m and slide rail 8n, since the friction factors of sliding slide way 8m and slide rail 8n are far less than that of second friction block 3b and friction part 5, thereby the friction can be omitted. Under the former pressure, a friction is generated between friction part 5 in motion and second friction block 3b. As the pressure is increased, the friction between second friction block 3b and friction part 5 is also increased. When the friction is higher than the elastic force of resetting spring 7a and resistant forces, such as other frictions, etc., second friction block 3b would follow friction part 5 to move in a same direction, while under the limitation of convex shaped limiting device 2g, the displacement of second friction block 3b between power boosting component 2 is not allowed in the moving direction. Therefore, second friction block 3b and power boosting component 2 move in a same direction, under the friction between friction part 5 and second friction block 3b, an amplified power, i.e., the boosting power, is generated. The boosting power is output by power boosting block 2a on power boosting component 2 to push the part which needs to be controlled (e.g. in FIG. 3, piston push rod 4c outputs the liquid from hydraulic tube outlet 4d).

### Embodiment 3

As shown in FIG. 6 and FIG. 7, the power booster of embodiment 3 is basically the same as embodiment 1 or embodiment 2 in structure, the differences are that spring 7a of resetting device 7 in embodiment 1 is replaced by leaf spring 7b, slide groove 8a and slide rod 8b are replaced by slide ditch 8c and slide block 8d. One end of the leaf spring 7b is fixedly or movably connected to power boosting component 2, and another end is also fixedly or movably connected to power boosting support 6. Slide ditch 8c and slide block 8d are respectively fixed on power boosting component 2 and power boosting support 6.

One end of the leaf spring 7b is fixed on power boosting component 2, another end is movably connected to power boosting support 6, or one end of the leaf spring 7b is movably connected to power boosting component 2, another end is fixed on power boosting support 6. Slide block 8d is fixed on power boosting component 2, slide ditch 8c is fixed on power boosting support, or slide ditch 8c is fixed on power boosting component 2, slide block 8d is fixed on power boosting support. Slide ditch 8c is enabled to move back and forth in slide ditch 8c.

### Embodiment 4

As shown in FIG. 8 and FIG. 9, the power booster of embodiment 4 is basically the same as embodiment 1 or embodiment 2 in structure, the differences are that hydraulic tube inlet 1a, liquid cylinder 1b, piston 1c of conversion device 1 are removed, while tension cable support 1d, cam 1e, camshaft 1f, and cam support 1g are added. The tension cable support 1d is fixedly connected to power boosting component 2. Cam 1e is arranged on camshaft 1f, which is arranged inside cam support 1g.

The tension cable support 1d is fixed on power boosting component 2. Cam 1e is arranged on camshaft 1f which is arranged inside cam support 1g. Cam support 1g is fixed on power boosting component 2. The tension wire of the tension cable of the controlling device is movably or fixedly connected to cam 1e, which is movably connected to first friction block 3a. First friction block 3a, following the transmission of cam 1e, is enabled to move back and forth along the direction perpendicular to the moving direction of friction part 5.

The power booster described in embodiment 3 is basically the same as embodiment 1 at work, the difference is that the conversion device 1 of the present embodiment is changed from hydraulic type to mechanical type. When the cam 1e rotates, it pushes first friction block 3a to move towards friction part 5, and contact with each other to generate friction.

### Embodiment 5

As shown in FIG. 10 and FIG. 11, the power booster of embodiment 5 is basically the same as embodiment 1 or embodiment 2 in structure, the differences are that power boosting block 2a, hydraulic cylinder 4a, piston 4b, piston push rod 4c, and hydraulic tube outlet 4d are removed. Power boosting component 2 includes power boosting toothed block 2c. Driving component 4 includes gear 4f, cam 4g, and camshaft 4h. Friction part 5 includes rotating drum 5b. Sliding device 8 includes slide ring 8e, and slide shaft 8f. Power boosting toothed block 2c is fixedly connected to power boosting component 2, and gear 4f is fixedly connected to driving component 4. Rotating drum 5b is arranged inside and movably connected to power boosting support 6. Slide ring 8e is fixedly connected to power boosting component 2, and slide shaft 8f is also fixedly connected to power boosting support 6.

The power boosting toothed block 2c is fixed on power boosting component 2. Gear 4f is fixedly connected to cam 4g, and gear 4f and cam 4g are arranged on camshaft 4h, which is fixedly or movably connected to power boosting support 6. Slide ring 8e is fixed on power boosting component 2, slide shaft 8f is also fixed on power boosting support 6, and slide ring 8e is enabled to rotate around slide shaft 8f.

### Embodiment 6

As shown in FIG. 12 and FIG. 13, the power booster of embodiment 6 is basically the same as embodiment 1, embodiment 2 or embodiment 5 in structure, the differences are that power boosting block 2a is removed, and the power boosting component is connected to piston push rod 4c.

The power booster of the present embodiment at work is basically the same as embodiment 1, and embodiment 4, while the differences are that the power boosting component is directly connected to piston push rod 4c of the part that needs to be controlled.

What described above are only some typical embodiments of the power booster of the present invention. In light of the operating system of the mechanical apparatus, the exemplified conversion device 1 is determined to use the mature and conventional structure and method of hydraulic, mechanical, pneumatic, or power driven types etc., such as hydraulic tube, pull rod, push rod, connecting rod, wire harness, hydraulic cylinder, piston, cam, lever, gear, rack, pneumatic control, electronic control and a combination thereof.

The guiding sliding device can be in a shape of groove, pillar, tooth, ring, bearing and the like. The friction part can be a part that moves in arc line or straight line.

The power boosting component 2 can be provided with or without power boosting block 2a. In case of no power boosting block 2a, the part that needs to be controlled can be directly connected to power boosting component 2.

Resetting device 7 can be formed by spring, leaf spring or rubber, or share the resetting device with the machine, or even utilize gravity. Power boosting friction block 3 can be fixedly or movably fixed on power boosting component 2, such as used for the brakes of bicycles, motorbikes, and cars etc.

The power booster of the present invention substantially includes conversion device 1, power boosting component 2, power boosting friction block 3, friction part 5, and power boosting support 6. The external force, by conversion device 1, enables power boosting friction block 3 and friction part 5 to contact with each other and generate friction which drives power boosting component 2 to move. The fore for moving, which is the amplified boosting power, is bigger than the introduced controlling force.

What is claimed is:

1. A power booster, comprising:
a conversion device, a power boosting component, a power boosting friction block, a friction part, a power boosting support, and a sliding device;
wherein the conversion device is fixed on the power boosting component, the power boosting friction block is fixed on the power boosting component, the power boosting friction block and the friction part contact with each other after being pressed, the power boosting component is movably connected to the power boosting support, the friction part is movably connected to the power boosting support, the sliding device is connected to the power boosting component and the power boosting support.

2. The power booster of claim 1, wherein, the conversion device comprises a hydraulic tube inlet, a hydraulic cylinder, and a first piston; wherein the hydraulic tube inlet is fixedly connected to the hydraulic cylinder, the hydraulic cylinder is fixedly connected to the power boosting component, the piston is arranged inside the hydraulic cylinder, and the first piston is movably connected to the power boosting friction block.

3. The power booster of claim 1, wherein, the conversion device comprises a tension cable support, a cam, a camshaft, and a cam support;
wherein the tension cable support is fixedly connected to the power boosting component, the cam is arranged on the camshaft, the camshaft is arranged inside the cam support, the cam support is fixedly connected to the power boosting component, the cam radially rotates around the camshaft, and the cam is movably connected to the power boosting friction block.

4. The power booster of claim 1, wherein, further comprising a resetting device, wherein,
the power boosting component includes a power boosting block and a concave shaped limiting device,
the power boosting friction block includes a first friction block,
the resetting device includes a spring,
the sliding device includes a slide groove and a slide rod;
the power boosting block is fixed to the power boosting component, the concave shaped limiting device is fixed to the power boosting component, the first friction block is connected to the concave shaped limiting device, one end of the spring is fixed to the power boosting component is fixed to the power boosting support, the slide groove and the slide rod are respectively fixed to the power boosting component and the power boosting support, and the slide rod is configured to move back and forth along the slide groove.

5. The power booster of claim 1, further comprising a resetting device, wherein,
the power boosting component includes a power boosting block, and a convex shaped limiting device, the power boosting friction block includes a second friction block, the resetting device includes a leaf spring, the sliding device includes a slide way, and a slide rail;
the power boosting block is fixed to the power boosting component, the convex shaped limiting device is fixed to the power boosting component, the second friction block is connected to the convex shaped limiting device, one end of the leaf spring is movably connected to the power boosting component, an other end of the leaf spring is fixed to the power boosting support, the slide way and the slide rail are respectively fixed to the power boosting component and the power boosting support, and the slide rail is configured to move back and forth along the slide way.

6. The power booster of claim 1, further comprising a resetting device, wherein the resetting device, includes a leaf spring, the power boosting friction block includes a second friction block, the second friction block is connected to the convex shaped limiting device, one end of the leaf spring is fixed to the power boosting component, an other end of the leaf spring is movably connected to the power boosting support.

7. The power booster of claim 1, wherein, the power boosting component includes a power boosting toothed block, the sliding device includes a slide ring, and a slide shaft; the power boosting toothed block is fixed to the power boosting component, the slide ring is fixed to the power boosting component, the slide shaft is fixed to the power boosting support, the slide ring is arranged around the slide shaft, and the slide ring slides along the slide shaft.

8. The power booster of claim 1, wherein, the friction pan includes a turntable is arranged inside and movably connected to the power boosting support, the power boosting friction block and the turntable contact with each other after being pressed.

9. The power booster of claim 1, wherein, the friction part includes a rotating drum, the rotating drum is arranged inside and movably connected to the power boosting support, the power boosting friction block and the rotating drum contact with each other after being pressed.

10. The power booster of claim 2 wherein, the friction part includes a turntable; the turntable is arranged inside and movably connected to the power boosting support, the power boosting friction block and the turntable contact with each other after being pressed.

11. The power booster of claim 3 wherein, the friction part includes a turntable; the turntable is arranged inside and movably connected to the power boosting support, the power boosting friction block and the turntable contact with each other after being pressed.

12. The power booster of claim 4 wherein, the friction part includes a turntable; the turntable is arranged inside and movably connected to the power boosting support, the power boosting friction block and the turntable contact with each other after being pressed.

13. The power booster of claim 5 wherein, the friction part includes a turntable; the turntable is arranged inside and movably connected to the power boosting support, the power boosting friction block and the turntable contact with each other after being pressed.

14. The power booster of claim 6 wherein, the friction part includes a turntable; the turntable is arranged inside and movably connected to the power boosting support, the power boosting friction block and the turntable contact with each other after being pressed.

15. The power booster of claim 7 wherein, the friction part includes a turntable; the turntable is arranged inside and movably connected to the power boosting support, the power boosting friction block and the turntable contact with each other after being pressed.

16. The power booster of claim 2 wherein, the friction part includes a rotating drum, the rotating drum is arranged inside and movably connected to the power boosting support, the power boosting friction block and the rotating drum contact with each other after being pressed.

17. The power booster of claim 3 wherein, the friction part includes a rotating drum, the rotating drum is arranged inside and movably connected to the power boosting support, the power boosting friction block and the rotating drum contact with each other after being pressed.

18. The power booster of claim 4 wherein, the friction part includes a rotating drum, the rotating drum is arranged inside and movably connected to the power boosting support, the power boosting friction block and the rotating drum contact with each other after being pressed.

19. The power booster of claim 5 wherein, the friction part includes a rotating drum, the rotating drum is arranged inside and movably connected to the power boosting support, the power boosting friction block and the rotating drum contact with each other after being pressed.

20. The power booster of claim 6 wherein, the friction part includes a rotating drum, the rotating drum is arranged inside and movably connected to the power boosting support, the power boosting friction block and the rotating drum contact with each other after being pressed.
